(19) United States
(12) Patent Application Publication
(10) Pub. No.: US 2024/0181765 A1
(43) Pub. Date: Jun. 6, 2024

(54) COATING MATERIALS FOR HIGH TEMPERATURE SURFACES

(71) Applicants: Angelo MIRETTI, Seveso (IT); Mario GENTILE, Limbiate (IT)

(72) Inventors: Angelo MIRETTI, Seveso (IT); Mario GENTILE, Limbiate (IT)

(21) Appl. No.: 18/226,205

(22) Filed: Jul. 25, 2023

Related U.S. Application Data
(60) Provisional application No. 63/430,566, filed on Dec. 6, 2022.

(51) Int. Cl. B32B 33/00; B32B 17/02

(52) U.S. Cl. CPC B32B 33/00; B32B 17/02; B32B 2260/021; B32B 2260/044; B32B 2262/101; B32B 2262/108; B32B 2307/304; B32B 2307/3065; B32B 2315/085

(57) ABSTRACT

Novel fire-proof thermal-insulation coating materials are disclosed formed primarily by mixing granulated Rockwood with liquid vermiculite (i.e., expanded vermiculite mixed with water). Also disclosed are methods for producing the coating materials and for applying the novel coating materials and additional layers to selected surfaces which can reach excessive temperatures (e.g., above 135° C.) so as to limit the maximum temperature of the outer exposed surfaces of the coating layers.

### CLAIM OF PRIORITY

This invention claims priority based on U.S. Provisional Application Ser. No. 63/430,566 filed Dec. 6, 2022 titled COATING MATERIALS FOR HIGH TEMPERATURE SURFACES whose teachings are incorporated herein by reference.

### BACKGROUND OF THE INVENTION

This invention relates to thermal insulation layers, methods of forming same and to the combination of thermal insulation layers with other layers to form a moldable insulation coating which may be applied to cover surfaces subject to high temperatures (e.g., in excess of 135° C.).

In many applications, such as in the exhaust system of internal combustion engines and like applications, the outer surfaces of certain engine and exhaust components and the intercoupling pipes exceed a preset temperature (e.g., 135° C.). Many pieces of equipment (e.g., internal combustion operated industrial machinery) have to be operated in areas where gases and flammable substances are present. The heat generated by the engines and the exhaust fumes of these pieces of equipment may cause the gases and/or flammable substances present in the area to ignite and/or explode. It is therefore necessary to reduce the external (i.e., exposed) surface temperature of the pieces of equipment and associated pipes.

As stated, in many applications, if the temperature of the exposed surface of an engine and/or exhaust components exceed a certain temperature, the heat generated by the engine parts can cause flammable gases and/or combustible dusts present in the atmosphere to ignite and/or explode.

Most prior art thermal insulation schemes are not suitable in potentially explosive atmospheres as they are not gas and/or dust tight. Consequently, high temperature exposed surface can be in contact with flammable gases and/or dust particles resulting in fire and/or explosions. Schemes to overcome these problems are generally not simple, efficient and/or cost effective.

There is therefore a continuing need for:
(a) an efficient, cost effective technology easily achievable to manufacture a thermal insulation material for high temperature;
(b) Thermal insulation that is gas and dust tight; and
(c) Not subject to corrosion.

### SUMMARY OF THE INVENTION

Applicants' invention presents a solution to the above problem(s) in that there is provided: (a) novel fire-proof thermal-insulation materials; (b) a method for manufacturing same: and (c) a coating system for applying the novel thermal-insulation fireproof materials and additional layers to surfaces which can reach excessive temperatures (e.g., above 135° C.) so as to limit the maximum temperature of the exposed surfaces.

Applicants' invention includes forming a novel moldable fire-proof thermal-insulation material (also referred to herein as “HANDEX”) formed primarily of two components:
(a) Granulated Rockwool which is a mineral fibre product manufactured to offer protection in extreme temperature situations. Granulated Rockwool selected for use in practicing the invention typically has a thermal conductivity equal to or better than λ=0.035 W/(mK); and
(b) Expanded vermiculite (EV) which is a hydrous phyllosilicate mineral having low weight and excellent fire endurance performance. Specifically, EV has a low thermal conductivity (0.04-0.14 W/m K), low density (bulk density 80-120 kg/m³), and is chemically inert and non-toxic.

Note that as used herein and in the appended claims: The symbol “A” refers to the conductivity of a substance; “W” is watts, “m” is meters and “K” is degrees Kelvin.

The HANDEX layer may be used as a first coating layer overlying the “outer” surface of an engine and/or exhaust components which may exceed a given temperature (e.g., 135° C.) such that the external or exposed surface of the HANDEX layer is below that given temperature (e.g., 135° C.).

Another aspect of the invention includes the formation of a layer of non-flammable thermo-glass fabric composed of E-glass fiber (referred to herein as FIBEREX) imbued with a special glue (referred to herein as GLUEX) formed by mixing expanded vermiculite (EV) with water.

A still further aspect of the invention is the application of an HANDEX LAYER, a FIBEREX+GLUEX layer and other selected protective and decorative layers to an underlying surface, whose temperature may exceed a given value, such that the temperature of the outer/exposed surface of the coating layer does not exceed the given temperature.

### BRIEF DESCRIPTION OF THE DRAWINGS

In the accompanying drawings, which are not drawn to scale, like reference characters denote like components, and

FIGS. 1-5 are isometric drawings of a pipe covered with various thermally insulating and protective layers in accordance with the invention;

FIGS. 5A and 6 are cross-sectional diagrams of a pipe covered with various thermally insulating and protective layers in accordance with the invention; and

FIG. 7 is a cross-sectional diagram of FIG. 6 illustrating the effectiveness of applying the coating layers of the invention to a selected surface to reduce the temperature at the outer/exposed surface of the coating layers.

### DETAILED DESCRIPTION OF THE INVENTION

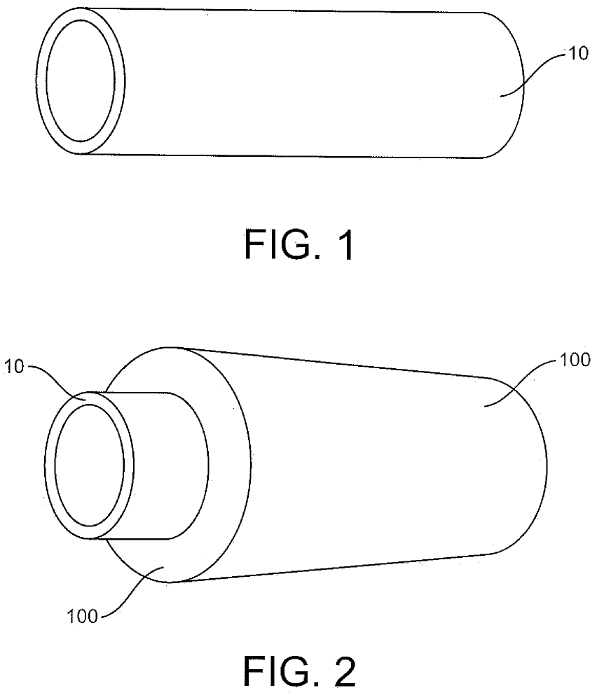

As shown in FIGS. 1-7, in accordance with the invention, a multi-layer thermally insulating coating (referred to herein as COATEX Evo) is applied to a pipe 10 whose surface temperature may exceed a desired temperature (e.g., 135° C.). It should be understood that pipe 10 is used only for purpose of illustration. The various inventive coatings may be applied to any interior surface whose temperature may exceed a desired level (e.g., 135° C.). The inventive thermally insulating materials are applied to such surfaces to reduce the external or exposed surface temperature of the coating layer to a temperature that does not exceed a desired level.

The multi-layer thermally insulating coating (COATEX Evo) includes:
(a) a first novel thermally insulating layer 100 (also referred to herein as HANDEX);
(b) a second layer 200 (also referred to herein as FIBEREX+GLUEX), overlying layer 100, which functions to protect the integrity of the underlying layer 100 while also providing additional thermal insulation. The second layer 200 includes a layer of FIBEREX covered with a special glue compound (also referred to herein as GLUEX) so it adheres to the underlying layer 10 and to any overlying layers (e.g., 300 or 400).
(c) a third layer 300 (also referred to herein as NOREX), which may be optional, overlies layer 200. Layer 300 is an incombustible liquid phenolic resin which functions to render the underlying layers dust tight, gas tight and corrosion resistant; and
(d) a fourth additional layer 400 (also referred to herein as Varnish), overlies layer 300. Layer 400 is intended to be a high temperature paint to provide any selected color to the underlying layers.

Referring to FIG. 1 there is shown a pipe 10 which may be part of an exhaust system (not shown) and wherein high temperature exhaust gases (much above 135° C.) pass through the pipe and the exhaust system.

In accordance with the invention, pipe 10 as well as other selected components (e.g. manifold, turbocharger and any component whose surface temperature may exceed 135° C.) are coated with all, or selected, layers of COATEX Evo as described below. Referring to FIG. 2 there is shown the application of a layer 100 of the moldable compound “HANDEX” easily molded by hand or any appropriate tool (e.g., a spatula) to pipe 10.

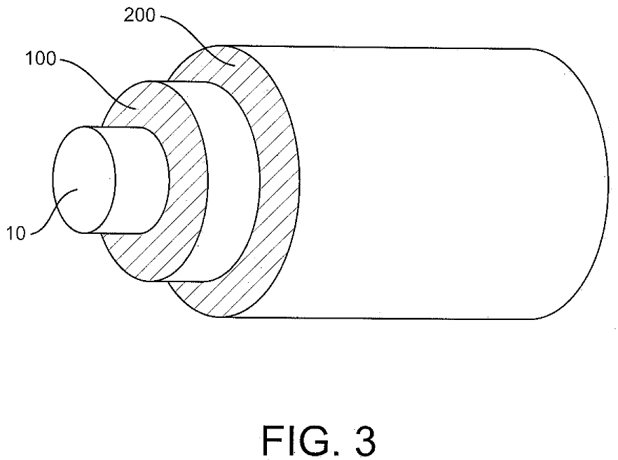

Referring to FIG. 3 there is shown the application of a layer 200 of FIBEREX plus GLUEX over the HANDEX layer.

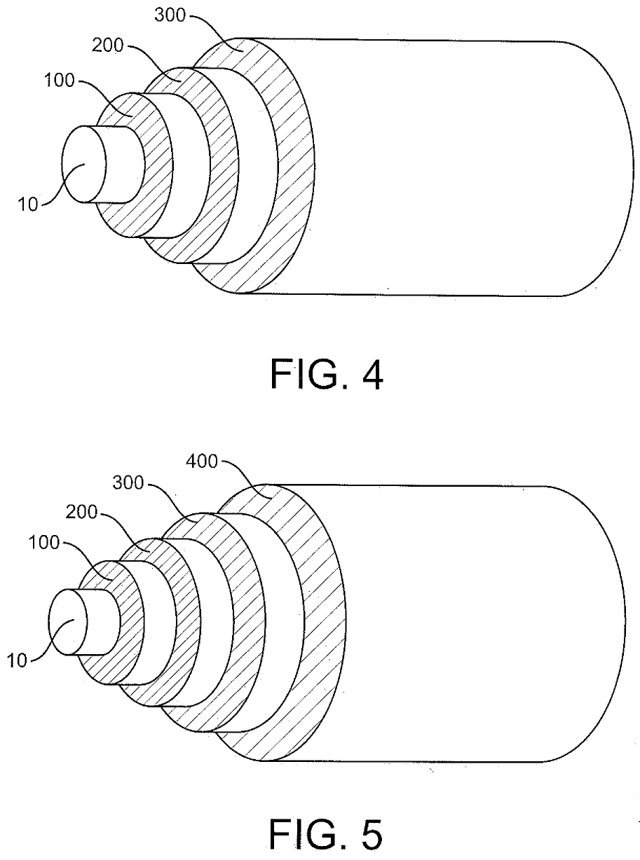

Referring to FIG. 4 there is shown the application of an incombustible phenolic resin “NOREX” layer 300 over the FIBEREX plus GLUEX layer 200. The NOREX layer protects the underlying layers from corrosive agents and even from impact.

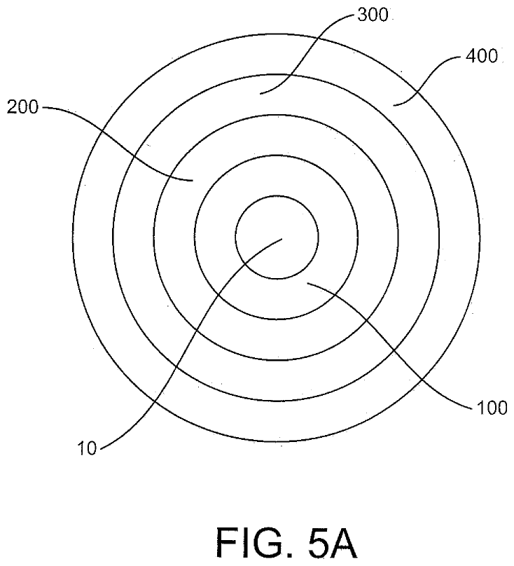

Referring to FIG. 5 there is shown the application of a high temperature varnish (paint) layer 400 over layer 300 to complete the coating process.

Referring to FIG. 5A there is shown a cross sectional view of the pipe 10 and the coating layers applied to the underlying pipe 10 and above each other.

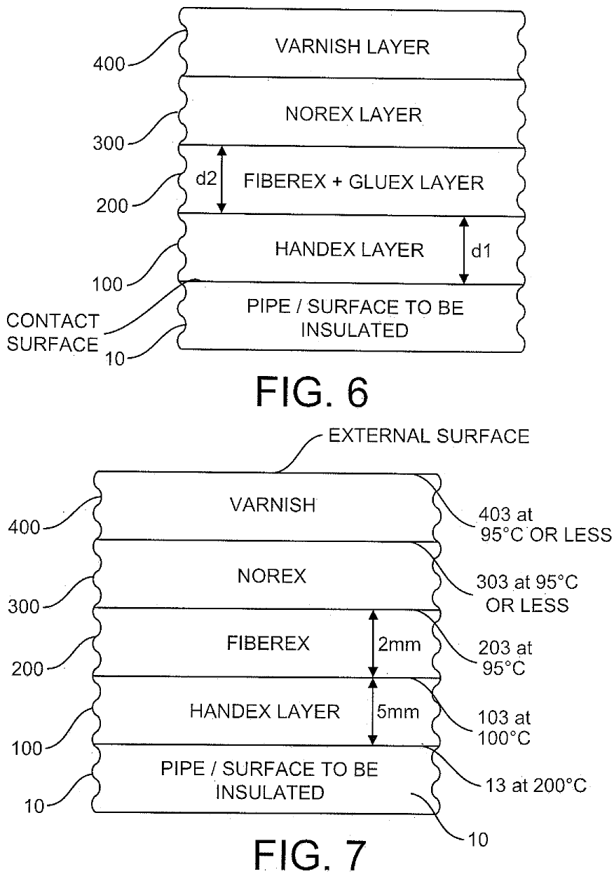

Referring to FIGS. 6 and 7 there are shown cross-sectional diagrams of a pipe 10 covered with the various thermally insulating and protective layers in accordance with the invention.

The different layers are designed to provide desired characteristics, the first layer 100 (“HANDEX”) applied to the surface of pipe 10 is a thermally insulating compound moldable by hand and or any appropriate tool (e.g., a spatula) and dried to reduce the external surface temperature of the coated component; (e.g., to obtain an external surface temperature under 135° C.). HANDEX is highly malleable to enable the coating of irregular surface as well as regular surfaces.

Layer 100 (HANDEX), intended for use in potentially explosive atmospheres, is a thermally insulating compound made of liquid vermiculite and Granulated Rockwool. It is nonflammable and heat resistance (above to 800° C.). It also has good sealing and adhesion qualities.

To form HANDEX in accordance with the invention, (i) Expanded vermiculite (EV) is mixed with water to produce liquid vermiculite (LV) typically having a thermal conductivity equal to or better than λ=0.063 W/(mK); and (ii) the liquid vermiculite (LV) is mixed with Granulated Rockwool to form the material referred to as HANDEX.

A method for preparing the fire-proof thermal-insulation compound (HANDEX) in accordance with the invention includes the following steps:
i—Expanded vermiculite (EV) is processed to produce an liquid vermiculite (LV) by mixing expanded vermiculite with water (preferably distilled). In one embodiment the weight ratio of these two components was 700 grams of expanded vermiculite to one (1) liter of water (i.e., 1000 grams of water).
ii—The EV and water mixture is then put in a stirrer to be mixed and stirred, at a stirring rate of 25000 rev/min for 6 min to 7 min, at 20° C. to 30° C. ambient temperature, to produce the desired liquid vermiculite (LV) mixture having a thermal conductivity equal to or better than λ=0.063 W/(mK).
iii—The liquid vermiculite (LV) was then mixed with granulated Rockwool, having a thermal conductivity equal to or better than λ=0.035 W/(mK), in a weight ratio of 2.8 kilogram granulated Rockwool to 630 grams of liquid vermiculite (LV). The weight ratio of the liquid vermiculite (LV) and the granulated Rockwool may be varied by ±10%.
iv—The mixture of the liquid vermiculite (LV) and the granulated Rockwool is then put into a stirrer to be mixed and stirred at a stirring rate of 1500 rev/min and at 20° C. to 30° C. temperature, until the resulting produced mixture (referred to herein as “HANDEX”) is homogeneous.

The resultant HANDEX layer which is formed of a combination of granular Rockwool and liquid vermiculite is a novel thermal insulating product having the following features:
a—HANDEX is free from any chemical additives, is easily molded or shaped and it is easy to manufacture with highly advantageous production costs (i.e., it is very cost effective to manufacture).
b—HANDEX has a thermal conductivity in the range of 0.013 W/mK to 0.023 W/mK [Mario: check for accuracy]
c—HANDEX may be applied to any selected surface and to have any desired thickness (e.g., it may range from less than 5 millimeters to more than 10 millimeters) to provide a desired/selected degree of thermal insulation. The amount of HANDEX applied may be measured with a thickness gauge.
d—The ratio of the components forming HANDEX may be controlled to ensure the right quality of the product; although some variation may be entertained.
e—In particular embodiments, the granulated Rockwool used was made by Rockwool International and the expanded vermiculite (EV) used was made by Unistara. But any materials having essentially the same characteristics may be used instead. Thus, a layer of HANDEX may be applied to any selected surface to provide thermal insulation and to effectively reduce the temperature of the “external” or “exposed” surface of the coating layer; where the external or exposed surface refers to the surface on the side of the HANDEX layer most distant from the surface to be insulated.

In accordance with the invention, as shown in the Figures, additional layers may be superimposed on the HANDEX layer 100 to provide additional beneficial features. An additional layer 200, overlying layer 100, may include a FIBEREX layer (defined below) mixed or impregnated with a fire proof special high temperature glue called GLUEX (defined below) to enable good adhesion to the HANDEX layer.

The second layer 200 “FIBEREX” applied on HANDEX, as shown in the figures (see FIGS. 3 and 6), includes a non-flammable thermo-glass fabric composed of E-glass fiber. The FIBEREX layer 200 is formed of a glass fiber fabric for high temperature operation. It is a textured and heat cleaned “E” glass fiber fabric. In one embodiment of the invention products made by HILTEX were used. The fabric made from raw materials like E-glass have a high degree of resistance to high temperatures, excellent thermal and acoustic insulation properties, great mechanical strength, versatile implementation possibilities and uncomplicated processing characteristics. Final products have good flexibility, are smooth and have outstanding insulating characteristics.

The needed quantity of FIBEREX for an application was cut from a roll.

The FIBEREX layer was covered or impregnated with the GLUEX mixture for adhering to the HANDEX layer. That is, the glass fiber fabric FIBEREX may be dipped into the GLUEX mixture or the GLUEX can be applied (e.g., by a paint brush) to both sides of the fabric.

GLUEX may be formed using expanded vermiculite which has a thermal conductivity equal to or better than λ=0.063 W/(mK) mixed with water.

Processing steps for forming GLUEX include:
i—Mixing 200 grams of expanded vermiculite to 1000 grams (1 liter) of water (where the weight ratios may be varied by plus or minus 10%); and
ii—Putting the mixture into a stirrer to be mixed and stirred. In one embodiment, stirring was at a rate of 25000 rev/min for 7 min, to obtain the GLUEX mixture.

Typically the GLUEX layer is in liquid form and is applied to (both surfaces of) the FIBEREX layer 200 by either dipping the FIBEREX into the GLUEX or by applying GLUEX with any suitable instrument to the inner and outer surfaces of FIBEREX. So, the “FIBEREX” layer is effectively permeated with the special high temperature glue GLUEX, as described above.

After being applied and then drying GLUEX exhibits a high degree of adhesion.

The FIBEREX+GLUEX layer 200 functions as an additional thermal insulating shell and as a protective cover to the HANDEX layer 100 from any external agents. The thickness of the FIBEREX+GLUEX layer may range from less than 2 mm to more than 4 mm. The thermal conductivity of the layer is in the range of 0.04 W/(mK). So it adds to the thermal insulation of the underlying surface.

The third layer 300, which is optional, is made of a phenolic resin “NOREX” designed to protect the integrity of the underlying layers. NOREX has excellent corrosion and temperature resistance, outstanding dimensional stability, high resistance to creep at elevated temperatures, low humidity absorption, It can be applied in any suitable manner (e.g., by brush like paint).

The fourth layer 400 is a high temperature varnish which has a purely aesthetic function. It may be chosen to have any desired color making the surface color homogeneous.

Referring to FIG. 7 there is shown a pipe or any surface having a surface temperature of, for example, 200° C. degrees and which needs to be insulated. The first HANDEX layer 100 having a thermal conductivity of approximately 0.2 W/(mK) and selected to be 5 mm thick functions such that its external surface 103 of coating layer 100 will be approximately 100° C. degrees.

The second FIBEREX+GLUEX LAYER 200 having a thermal conductivity of approximately 0.2 W/(mK) and selected to be 2 mm thick functions such that the external surface 203 of coating layer 200 will be approximately 95° C. degrees.

The combination of coating layers 100 and 200 thus function to reduce the external exposed surface temperature to a safe level.

The third Norex layer 300 does not reduce the temperature significantly, but it adds dust and gas tightness and corrosion resistance.

The fourth Varnish layer does not reduce the temperature significantly, but is used to provide a desired appearance.

As seen from the above, the thermally insulating materials of the present invention and their application provide many benefits and improvements over the prior art. For example:
(1) The first thermally insulating layer 100, HANDEX, which is a fire-proof thermal-insulation moldable compound, is an inorganic-non-metallic material. It has an A1 fire-proof level (i.e., it is completely non-combustible), has a good product durability, provides excellent thermal insulation and fireproofing, is corrosion resistant and exhibits high degree of durability.
(2) The second fire-proof thermal-insulation layer 200, in accordance with the invention, is made of a glass fiber fabric (FIBEREX) impregnated with a special-glue adhesive (GLUEX). The layer 200 has a low coefficient of thermal conductivity and good thermal-insulation performance.
(3) The third layer 300, referred to as NOREX, is a liquid phenolic resin which protects the underlying layers. The NOREX layer functions to protect the underlying layers (100 and 200) from peeling or being scratched or being acted upon by dust and corrosive particles in the surrounding atmosphere.
(4) The fourth layer 400, referred to as Varnish, is a high temperature paint to provide a selected color.

The layers 100, 200, 300 and 400 may be applied to an underlying surface at ambient temperature and then allowed to dry.

The most important layer is the first layer 100 made with HANDEX, whose thickness may be varied and controlled by measuring it with a thickness gauge or any other suitable instrument.

The layers 200 (FIBEREX+GLUEX) and 300 (NOREX) function as a protective shell for the HANDEX layer 100. The FIBEREX+GLUEX layer 200 when dried has a good adhesive property. The NOREX layer 300 made of liquid phenolic resin also has good adhesive property and good hardness. The fourth layer 400 is a high temperature varnish (paint).

The multi-layer thermal insulation system of the present invention can be used to coat any and all components and surfaces which are subject to high temperatures (e.g., in excess of 135° C.). It provides fireproof thermal insulation while also being corrosive resistant gas and dust tight. The coating system of the invention can thus be used to make the components of an exhaust system, or any selected surface, fire proof and/or explosion proof.

The coating system of the invention, which is referred to herein as Coatex Evo and which includes the application and use of layers 100, 200, 300 and 400, can be used universally in all applications requiring fireproof thermal insulation. The simplicity and universality of the multi-layer thermal insulating system of the invention reduces the manufacturing cost.

Another significant aspect of the coating layers of the invention, Coatex Evo, is that the layers do not include any thinner, hardener, or silicone and most elements used are inorganic and eco-friendly. The layers also function to protect against corrosive agents.

Coatex Evo is hand Moldable. It can be applied directly on the part to be insulated. It is useful for the thermal insulation and protection of hose and piping systems, exhaust system as well as components in the high-temperature range up to 800° C.

Applicants' COATEX Evo is a multilayer moldable inorganic coating product, It can be used to thermally insulate exhaust systems and similar parts in engine construction where a thermal reduction is required.

COATEX Evo properties:
Dust tight—With the application HANDEX and phenolic resin
Gas tight—With the application of HANDEX and phenolic resin
high temperature resistant—due to HANDEX and FIBEREX+GLUEX
Thermally insulating—due to HANDEX and FIBEREX+GLUEX
non-flammable—due to HANDEX and FIBEREX+GLUEX
Maintenance free—due to HANDEX and FIBEREX+GLUEX
Corrosion resistance—With the application of phenolic resin
anti-condensation—the materials used have this capacity
Suitable in potentially explosive atmosphere

Thus, as noted above features of the invention include
1. A multilayer thermal insulation coating to avoid risk of ignition or explosion caused by hot surface temperature of an explosion proof system components.
2. A multilayer thermal insulation coating suitable in explosion proof systems components and all those components that need a surface thermal reduction to reduce the external surface temperature of the component to obtain a reduction under 135° C.

What is claimed is:

1. A fire-proof thermal-insulation product comprising:
(a) an expanded vermiculite mixed with water to produce an liquid vermiculite; and
(b) a granulated Rockwool product mixed with the liquid vermiculite.

2. The fire-proof thermal-insulation product of claim 1, wherein the expanded vermiculite is a hydrous phyllosilicate mineral having low weight and low thermal conductivity; and
wherein the granulated Rockwool is an unbonded mineral fiber product.

3. The fire-proof thermal-insulation product of claim 1 wherein the weight ratio of the liquid vermiculite to the granulated Rockwood is in the range of 1 gram, plus or minus ten percent, of granulated Rockwool to 4.44 grams, plus or minus ten percent, of the liquid vermiculite.

4. The fire-proof thermal-insulation product of claim 3, wherein the weight ratio of the expanded vermiculite and the water with which it is mixed is 7 grams, plus or minus 10%, of expanded vermiculite for 10 grams, plus or minus 10%, of water.

5. The fire-proof thermal-insulation product of claim 3, wherein the liquid vermiculite and the granulated Rockwood are mixed in a stirrer at a predetermined stirring rate and temperature to produce a homogeneous compound.

6. The fire-proof thermal-insulation compound of claim 5, characterized in that the thermal conductivity (λ) of the product ranges from 0.013 W/mK to 0.023 W/mK; where “λ” refers to the conductivity of the substance; “W” is watts, “m” is meters and “K” is degrees Kelvin.

7. The fire-proof thermal-insulation product of claim 6, characterized in that the compound is moldable, nonflammable, heat resistance and has good sealing and adhesion qualities.

8. The fire-proof thermal-insulation product of claim 1, further including a fiber glass material permeated with an adhesive compound comprising a mixture of expanded vermiculite and water.

9. The fire-proof thermal-insulation product of claim 8, wherein for the adhesive compound the weight ratio of the expanded vermiculite and water is 2 grams, plus or minus ten percent, of expanded vermiculite for 10 grams, plus or minus ten percent of water.

10. A method for producing fire-proof thermal-insulation layers comprising the steps of:
(i) mixing a hydrous phyllosilicate mineral having low weight and low thermal conductivity with water and stirring the mixture for a selected amount of time at a selected temperature to produce an expanded liquid mixture;
(ii) mixing the expanded liquid mixture with an unbonded mineral fiber product in a stirrer; and
(iii) stirring the mixture of the unbonded mineral fiber and the expanded liquid mixture at a predetermined rate and at a predetermined temperature until the resulting mixture is homogeneous.

11. The method for producing fire-proof thermal-insulation layers as claimed in claim 10:
wherein said hydrous phyllosilicate mineral having low weight and low thermal conductivity is an expanded vermiculite product and said expanded liquid mixture is a liquid vermiculite mixture;
wherein said unbonded mineral fiber is a granulated Rockwool product;
wherein the weight ratio of the liquid vermiculite mixture to the granulated Rockwoood product is in the range of 4.4 grams, plus or minus ten percent, of the liquid vermiculite mixture for 1 gram, plus or minus ten percent, of the granulated Rockwood.

12. The method for producing fire-proof thermal-insulation layers as claimed in claim 11, wherein the weight ratio of the expanded vermiculite is 7 grams, plus or minus ten percent, to 10 grams, plus or minus ten percent, of water.

13. The method for producing fire-proof thermal-insulation layers as claimed in claim 11, further including forming a layer of fiber glass material permeated with an adhesive compound comprising a mixture of expanded vermiculite and water.

14. The method for producing fire-proof thermal-insulation layers as claimed in claim 13; wherein for the adhesive compound the weight ratio of the expanded vermiculite and water is: 2 grams, plus or minus ten percent, of expanded vermiculite for 10 grams, plus or minus ten percent of water.

15. A method for thermally insulating a selected surface comprising the steps of: applying coating layers to the selected surface at least one of the layers being a mixture of liquid vermiculite and granulated Rockwool.

16. The method for thermally insulating a selected surface as claimed in claim 15, including the step of applying a second layer of a thermo-glass fabric composed of a glass fiber permeated with a special high temperature glue composed of expanded vermiculite and water.

17. The method for thermally insulating a selected surface as claimed in claim 16 further including the steps of:
(i) applying a third layer overlying the second layer, said third layer composed of liquid phenolic resin; and
(ii) applying a fourth layer overlying the third layer, said fourth layer being a varnish layer of selected color.

18. The method for thermally insulating a selected surface as claimed in claim 15, wherein the mixture of liquid vermiculite (LV) and granulated Rockwool includes expanded vermiculite mixed with water in a given weight ratio and wherein the liquid vermiculite (LV) is mixed with the granulated Rockwool in a given weight ratio.

19. The method for thermally insulating a selected surface as claimed in claim 16, wherein the special high temperature glue composed of expanded vermiculite and water is formed by mixing EV and water in the ratio of 2 grams, plus or minus ten percent, of EV to every 10 grams, plus or minus ten percent, of water.

20. The method for thermally insulating a selected surface as claimed in claim 16, wherein the mixture of liquid vermiculite (LV) and granulated Rockwool is formed with the weight ratio of the liquid vermiculite to the granulated Rockwood being in the range of 1 gram, plus or minus ten percent, of granulated Rockwool to 4.44 grams, plus or minus ten percent, of the liquid vermiculite; and wherein the mixture of liquid vermiculite (LV) is formed with the weight ratio of 7 grams, plus or minus 10%, of expanded vermiculite for 10 grams, plus or minus 10%, of water.
